(19) United States
(12) Patent Application Publication
(10) Pub. No.: US 2014/0283317 A1
(43) Pub. Date: Sep. 25, 2014

(54) SYSTEM AND METHOD FOR IMPREGNATING, WITH A SOLVENT, A FABRIC FOR CLEANING THE BLANKET AND THE METAL PRINTING CYLINDER OF A PRINTING MACHINE

(71) Applicant: PAVAN FORNITURE GRAFICHE S.P.A., VERONA (IT)

(72) Inventor: Luca Pavan, Villafranca Di Verona (IT)

(21) Appl. No.: 14/348,469

(22) PCT Filed: Sep. 18, 2012
(86) PCT No.: PCT/EP2012/068308

§ 371 Date: Mar. 28, 2014

(30) Foreign Application Priority Data
Sep. 30, 2011 (IT) MI2011A001773

(51) Int. Cl. B08B 1/04; B08B 3/04

(52) U.S. Cl. CPC B08B 1/04; B08B 3/04
USPC 15/103.5; 134/9

(57) ABSTRACT

The system (1) for impregnating, with a solvent (2), a fabric (3) for cleaning the blanket and the metal printing cylinder of a printing machine includes at least one tank (4) suitable for being filled up to a certain level (9) with the solvent and at least one impregnating roller (6) placed in the tank in a position suitable for being partially immersed in the solvent, the impregnating roller having a coating made of a material having properties of resistance to the corrosion induced by the solvent and sufficient interfacial tension with the solvent to deliver a uniform micrometric film (11) of solvent toward the cleaning fabric, there being provided above the filling level of the tank an area of contact (8) between the impregnating roller and the cleaning fabric wherein the direction of the peripheral velocity to which the impregnating roller is subjectable is opposite to the direction of the feed velocity to which the cleaning fabric is subjectable, so that the impregnating roller, when driven in rotation, picks up a film of solvent which by contact impregnates the cleaning fabric being fed in the opposite direction.

### FIELD OF THE INVENTION

The present invention relates to a system and a method for impregnating, with a solvent, a fabric for cleaning the blanket and the metal printing cylinder of a printing machine.

### DESCRIPTION OF RELATED ART

In printing machines, particularly those of the offset type, there is envisaged an automatic cleaning of the blanket, also called rubber-coated sheet, and of the metal printing cylinder, in which a cleaning fabric suitably impregnated with a solvent is used.

The impregnated cleaning fabric is packaged in rolls of varying size and length which are stored until the time of use.

Perfect cleaning of the blanket and metal printing cylinder is fundamental for a correct execution of printing processes.

The effectiveness and rapidity of cleaning are obviously also tied to the availability of ready-to-use cleaning fabrics that have been correctly impregnated.

Systems for impregnating a cleaning fabric which carry out the impregnation by immersion, pressure or spraying have been present on the market for some time. An example of the afore-mentioned systems is shown in document DE10003161 that discloses a cleaning device having an input for a dry cleaning mat 11, a dampener 22 to dampen it with cleaning fluid 23 and an output for the dampened cleaning mat. The device is also provided with a wiper device 16, 17 to wipe surplus cleaning fluid off the mat.

Unfortunately, such impregnation systems do not always ensure the possibility of accurately and uniformly calibrating the impregnation of the cleaning fabric when the physicochemical characteristics of both the solvent and cleaning fabric vary.

The technical task that the present invention has set itself is thus to realize a system and method for impregnating, with a solvent, a fabric for cleaning the blanket and the metal printing cylinder of a printing machine which enable the aforesaid technical limitations of the prior art to be eliminated.

Within the scope of this technical task, one object of the invention is to realize a system and a method for impregnating, with a solvent, a fabric for cleaning the blanket and the metal printing cylinder of a printing machine which enable an accurate, uniform impregnation.

Within the scope of this technical task, one object of the invention is to realize a system and a method for impregnating, with a solvent, a fabric for cleaning the blanket and the metal printing cylinder of a printing machine which enable an impregnation that can be adjusted in terms of the amount of solvent impregnated in a unit of volume of cleaning fabric.

Another object of the invention is to realize a system and a method for impregnating, with a solvent, a fabric for cleaning the blanket and the metal printing cylinder of a printing machine which enable the impregnation to be adjusted with variations in the physicochemical characteristics of the solvent and cleaning fabric, for example in the viscosity of the solvent, density of the solvent and thickness of the cleaning fabric.

### SUMMARY OF THE INVENTION

The technical task, as well as these and other objects, according to the present invention, are achieved by realizing a system and a method for impregnating, with a solvent, a fabric for cleaning the blanket and the metal printing cylinder of a printing machine in accordance with the independent claims set forth hereunder.

The system and method for impregnating, with a solvent, a fabric for cleaning the blanket and the metal printing cylinder of a printing machine in accordance with the present invention are based on the fact that the impregnating roller, when driven in rotation, picks up a film of solvent which by contact impregnates the cleaning fabric being fed in the opposite direction.

The feed velocity of the cleaning fabric and the peripheral velocity of the impregnating roller are preferably adjustable independently from each other in order to make it possible to modify the degree of impregnation while ensuring an accurate and uniform micrometric impregnation.

The impregnation preferably takes place with a constant level of solvent in the tank so as to assure not only the attainment of the desired result, but also the reproducibility of the desired result in subsequent impregnation cycles.

Other features of the present invention are defined, moreover, in the dependent claims.

### BRIEF DESCRIPTION OF THE DRAWINGS

Additional features and advantages of the invention will be more apparent from the description of a preferred, but non-exclusive embodiment of the system and method for impregnating, with a solvent, a fabric for cleaning the blanket and the metal printing cylinder of a printing machine according to the invention, illustrated by way of non-restrictive example in the appended drawings, in which:

FIG. 1 schematically shows the impregnation system.

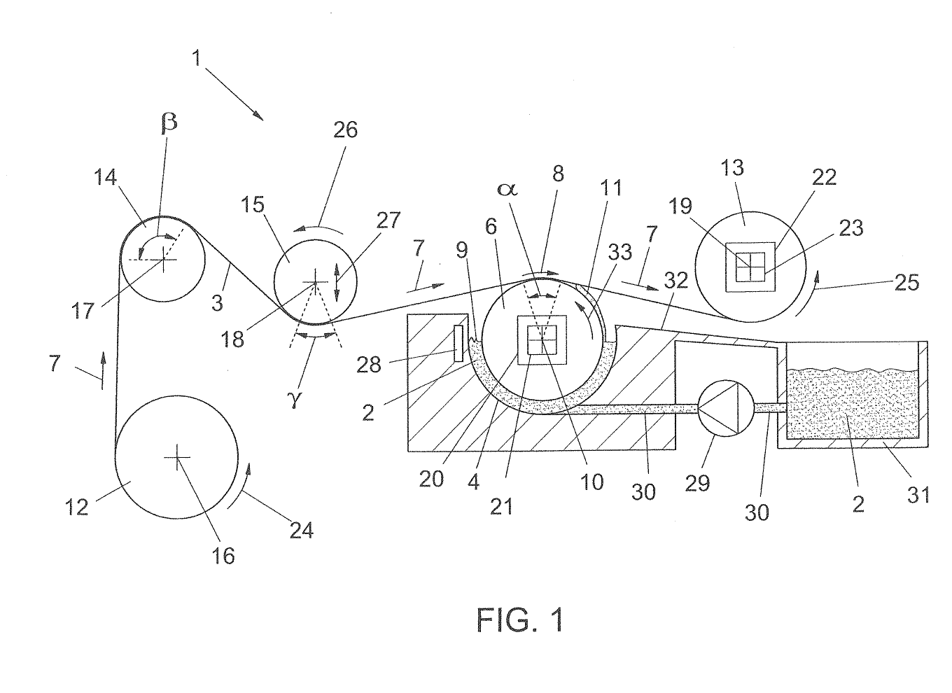

### DETAILED DESCRIPTION OF PREFERRED EMBODIMENTS OF THE INVENTION

With reference to the above-mentioned FIGURE, it schematically shows a system 1 for impregnating, with a solvent 2, a fabric 3 for cleaning the blanket and the metal printing cylinder of a printing machine.

The system 1 comprises at least one tank 4 suitable for being filled up to a certain level 9 with the solvent 2, and at least one impregnating roller 6 placed in the tank 4 in a position suitable for being partially immersed in the solvent 2.

Above the filling level 9 of the tank 4 there is provided an area of contact 8 between the impregnating roller 6 and the cleaning fabric 3 wherein the direction of the peripheral velocity to which the impregnating roller 6 is subjectable is opposite to the direction of the feed velocity to which the cleaning fabric 3 is subjectable, so that the impregnating roller 6, when driven in rotation, picks up a film 11 of solvent 2 which by contact impregnates the cleaning fabric 3 being fed in the opposite direction.

The impregnating roller 6 preferably has a coating made of a material having properties of resistance to the corrosion induced by the solvent 2 and sufficient interfacial tension with the solvent to deliver a uniform micrometric film 11 of solvent 2 toward the cleaning fabric 3.

The cleaning fabric 3 is slidable along a feed path 7, indicated with arrows, which passes through the area of contact 8 with the impregnating roller 6.

The area of contact 8 consists of an axial sector of the lateral surface of the impregnating roller 6 onto which the cleaning fabric 3 is wound by an angle α.

The tank 4 has a cylindrical internal delimiting surface whereupon the impregnating roller 6 is coaxially positioned.

The solvent 2 is thus disposed in the annular gap present between the lateral surface of the impregnating roller 6 and the internal lateral delimiting surface of the tank 4.

The system 1 comprises at least one roller 12 for unwinding the cleaning fabric 3 to be impregnated, at least one roller 13 for winding up the impregnated cleaning fabric 3, means for moving the cleaning fabric 3 along a feed path 7 which takes it from the unwind roller 12 to the windup roller 13 passing through the area of contact 8 with the impregnating roller 6, and means for driving the impregnating roller 6 in rotation.

The system 1 further comprises a framework (not shown) for supporting, in addition to the rollers 6, 12, 13, at least one return roller 14 and at least one adjustment roller 15 which serves to modify the extent of the area of contact 8 or, in other words, the width of the angle α.

The rollers 12, 14, 15, 6 and 13 are arranged in succession along the feed path 7 of the cleaning fabric 3 and are oriented with their respective axes 16, 17, 18, 10 and 19 parallel.

The feed path 7 of the fabric extends in a plane perpendicular to the axes 16, 17, 18, 10 and 19 of the rollers 12, 14, 15, 6 and 13.

The means for driving the impregnating roller 6 in rotation comprise a rotation drive motor 20 of the impregnating roller 6, connected to a variator 21 of its angular velocity of rotation. In particular, the variator 21 is a variator with a graduated scale of the revolutions of the motor 20.

The means for moving the cleaning fabric 3 comprise a rotation drive motor 22 of the windup roller 13, connected to a variator 23 of its angular velocity of rotation.

Advantageously, the control of the variator 23 is designed to automatically compensate for the progressive increase in the diameter of the roll of impregnated cleaning fabric 3, which, as it is wound, accumulates on the windup roller 13, with a progressive reduction in the angular velocity of the windup roller 13 so as to maintain a constant feed velocity of the cleaning fabric 3 along the feed path 7.

Advantageously, the adjustment of the angular velocity of rotation of the impregnating roller 6 performed by the variator 21 is independent of the adjustment of the angular velocity of rotation of the windup roller 13 performed by the variator 23.

The unwind roller 12 is supported idle and can be drawn in rotation in the direction of the arrow 24 when the windup roller 13 is driven in rotation in the direction of the arrow 25.

The return roller 14 around which the cleaning fabric 3 is wound by an angle β is fixed.

The adjustment roller 15 around which the cleaning fabric 3 is wound by an angle γ is supported idle and can be drawn in rotation in the direction of the arrow 26 when the windup roller 13 is driven in rotation in the direction of the arrow 25.

The axis 18 of the adjustment roller 15 is movable along an axis 27, indicated by a bi-directional arrow, and oriented in a plane perpendicular to the axis 18.

The adjustment roller 15 can be moved along the axis 27 so as to modify the configuration of the feed path 7, 8 of the cleaning fabric 3 in such a way as to adjust the extent of the area of contact 8, or, in other words, the width of the angle α.

The system 1 further envisages means for maintaining a constant level 9 of the solvent 2 in the tank 4.

The means for maintaining the constant level 9 set for the solvent 2 comprise a level sensor 28 for controlling a feed pump 29 present along a hydraulic connection line 30 between the tank 4 and a storage tank 31 for the solvent 2.

The feed pump 29 is preferably activated in a pulse mode to replenish the working level 9 whenever the detected level 9 falls, relative to the set value, beyond a pre-established threshold due to consumption of the solvent 2 which impregnates the cleaning fabric 3.

The means for maintaining the constant level 9 set for the solvent 2 further comprise an overflow 32 of the tank 4, designed to drain the solvent 2 directly into the tank 31 when the level thereof rises above a pre-established threshold relative to the set value.

The method for impregnating the cleaning fabric 3 appears evident from what has been described above and envisages, in short, partially immersing the impregnating roller 6 in the tank 4 filled up to the desired level 9 with the solvent 2, driving the windup roller 13 in rotation to slide the cleaning fabric 3 along the feed path 7, and driving the impregnating roller 6 in rotation with a peripheral velocity which in the area of contact 8 has a direction opposite to the direction of the feed velocity of the cleaning fabric 3 so that the impregnating roller 6 picks up a film 11 of solvent 2, which by contact impregnates the cleaning fabric 3 being fed in the opposite direction.

The direction of rotation of the impregnating roller is indicated by an arrow 33.

In order to obtain, in the area of contact 8, a peripheral velocity of the impregnating roller 6 in a direction opposite to the feed direction of the cleaning fabric 3, the windup roller 13 and impregnating roller 6 are driven in the same direction of rotation, anticlockwise, in particular, in the illustrated diagram.

Impregnation is achieved as soon as the solvent 2 comes into contact with the cleaning fabric 3 being fed in the opposite direction.

By penetrating in depth into the cleaning fabric 3, the film 11 of solvent 2 that comes into contact with the cleaning fabric 3 causes a momentary expulsion of any air that may be trapped in the fibres of the cleaning fabric 3, for a time that is sufficient to obtain a rapid impregnation of the fibres of the cleaning fabric 3. Due to a hygroscopic effect, moreover, the fibres of the cleaning fabric 3 retain the solvent 2, preventing the reabsorption of the expelled air.

The degree of impregnation can be adjusted by independently modifying the feed velocity of the cleaning fabric 3 and the peripheral velocity of the impregnating roller 6.

For example, in order to increase the degree of impregnation or allow the impregnation of a greater thickness of fabric the modulus of the feed velocity of the cleaning fabric 3 can be reduced and the modulus of the peripheral velocity of the impregnating roller 6 can be simultaneously increased if necessary.

The impregnation conditions can also be adjusted by modifying the extent of the area of contact 8 via the adjustment roller 15.

It has been ascertained in practice that the system and the method for impregnating, with a solvent, a fabric for cleaning the blanket and the metal printing cylinder of a printing machine according to the invention are particularly advantageous in virtue of the fact that the infinite combinations of values settable in the area of contact for the feed velocity of the cleaning fabric and the peripheral velocity of the impregnating roller enable the desired degree of impregnation to be established a priori and controlled with extreme flexibility, precision and reproducibility, irrespective of the physicochemical characteristics of the solvent and of the cleaning fabric.

The impregnation method envisaged by the invention does not suffer from the traditional limitation of having wastes of the solvent and energy necessary for totally and overabundantly saturating the cleaning fabric and subsequently removing the excess solvent.

The impregnation of the cleaning fabric does not take place, in fact, by immersion in a bath of solvent, by spraying of a solvent, or under pressure between cylinders, by spraying, but rather with a calibrated contact that lends the required degree of impregnation to the cleaning fabric.

The system and the method for impregnating, with a solvent, a fabric for cleaning the blanket and the metal printing cylinder of a printing machine thus conceived are susceptible of numerous modifications and variants, all falling within the scope of the inventive concept; moreover, all the details may be replaced with other technically equivalent ones.

In practice, all of the materials used, as well as the dimensions, can be any whatsoever according to need and the state of the art.

1. A system (1) for impregnating, with a solvent (2), a fabric (3) for cleaning the blanket and the metal printing cylinder of a printing machine, said system (1) comprising at least one tank (4) suitable for being filled up to a certain level (9) with the solvent (2) and at least one impregnating roller (6) placed in the tank (4) in a position suitable for being partially immersed in the solvent (2), there being provided above the filling level (9) of the tank (4) an area of contact (8) between the impregnating roller (6) and the cleaning fabric (3) wherein the direction of the peripheral velocity to which the impregnating roller (6) is subjectable is opposite to the direction of the feed velocity to which the cleaning fabric (3) is subjectable, so that the impregnating roller (6), when driven in rotation, picks up a film (11) of solvent (2) which by contact impregnates the cleaning fabric (3) being fed in the opposite direction, characterized in that said tank (4) has a cylindrical internal delimiting surface whereupon said impregnating roller (6) is coaxially positioned, the solvent (2) being disposed in an annular gap present between the lateral surface of said impregnating roller (6) and said internal lateral delimiting surface of the tank (4).

2. The system (1) for impregnating, with a solvent (2), a fabric (3) for cleaning the blanket and the metal printing cylinder of a printing machine according to claim 1, characterized in that it comprises at least one roller (12) for unwinding the cleaning fabric (3) to be impregnated, at least one roller (13) for winding up the impregnated cleaning fabric (3), means for moving the cleaning fabric (3) along a feed path (7) which takes it from the unwind roller (12) to the windup roller (13) passing through said area of contact (8), and means for driving the impregnating roller (6) in rotation.

3. The system (1) for impregnating, with a solvent, a fabric (3) for cleaning the blanket and the metal printing cylinder of a printing machine according to claim 2, characterized in that said means for driving the impregnating roller (6) in rotation comprise a drive motor (20) of the impregnating roller (6), connected to a variator (21) of its angular velocity of rotation.

4. The system (1) for impregnating, with a solvent, a fabric (3) for cleaning the blanket and the metal printing cylinder of a printing machine according to claim 2, characterized in that said means for moving the cleaning fabric (3) comprise a drive motor (22) of the windup roller (13), connected to a variator (23) of its angular velocity of rotation.

5. The system (1) for impregnating, with a solvent, a fabric (3) for cleaning the blanket and the metal printing cylinder of a printing machine according to claim 4, characterized in that said variator (23) automatically compensates for the progressive increase in the diameter of the roll of impregnated cleaning fabric (3), which, as it is wound, accumulates on the windup roller (13) with a progressive reduction in the angular velocity of the windup roller (13) so as to maintain a constant feed velocity of the cleaning fabric (3) along the feed path (7).

6. The system (1) for impregnating, with a solvent, a fabric (3) for cleaning the blanket and the metal printing cylinder of a printing machine according to claim 3, characterized in that the adjustment of the angular velocity of rotation of the impregnating roller (6) performed by the variator (21) is independent of the adjustment of the angular velocity of rotation of the windup roller (13) performed by the variator (23).

7. The system (1) for impregnating, with a solvent, a fabric (3) for cleaning the blanket and the metal printing cylinder of a printing machine according to claim 2, characterized in that the unwind roller (12) is supported idle.

8. The system (1) for impregnating, with a solvent, a fabric (3) for cleaning the blanket and the metal printing cylinder of a printing machine according to claim 1, characterized in that it features means for maintaining a constant level of solvent (2) in the tank (4).

9. The system (1) for impregnating, with a solvent, a fabric (3) for cleaning the blanket and the metal printing cylinder of a printing machine according to claim 8, characterized in that said means for maintaining a constant level of solvent (2) in the tank (4) comprise a level sensor (28) for controlling a feed pump (29) present along a hydraulic connection line (30) between the tank (4) and a storage tank (31) for the solvent.

10. The system (1) for impregnating, with a solvent, a fabric (3) for cleaning the blanket and the metal printing cylinder of a printing machine according to claim 8, characterized in that said means for maintaining a constant level of solvent (2) comprise an overflow (32) of the tank (4).

11. The system (1) for impregnating, with a solvent, a fabric (3) for cleaning the blanket and the metal printing cylinder of a printing machine according to claim 2, characterized in that it comprises at least one adjustment roller (15) onto which said cleaning fabric (3) is partially wound, the axis (18) of the adjustment roller (15) being movable so as to modify the configuration of the feed path (7) of the cleaning fabric (3) in such a way as to adjust the extent of said area of contact (8).

12. A method for impregnating, with a solvent (2), a fabric (3) for cleaning the blanket and the metal printing cylinder of a printing machine, said method comprising the steps of partially immersing at least one impregnating roller (6) in a tank (4) filled up to a certain level (9) with the solvent (2), sliding the cleaning fabric (3) along a feed path (7) which brings it into contact with the impregnating roller (6) in an area (8) above the filling level (9) of the tank (4), and driving the impregnating roller (6) in rotation with a peripheral velocity which in said area of contact (8) has a direction opposite to the direction of the feed velocity of the cleaning fabric (3), so that the impregnating roller (6) picks up a film (11) of solvent (2), which by contact impregnates the cleaning fabric (3) being fed in the opposite direction, characterized in that said step of partially immersing one impregnating roller (6) in a tank is carried out in a tank (4) having a cylindrical internal delimiting surface whereupon said impregnating roller (6) is coaxially positioned, the solvent (2) being disposed in an annular gap present between the lateral surface of said impregnating roller (6) and said internal lateral delimiting surface of the tank (4).

13. The method for impregnating, with a solvent, a fabric (3) for cleaning the blanket and the metal printing cylinder of a printing machine according to claim 12, characterized in that it adjusts the degree of impregnation by independently adjusting the feed velocity of the cleaning fabric (3) and the peripheral velocity of the impregnating roller (⁶).

14. The method for impregnating, with a solvent, a fabric for cleaning the blanket and the metal printing cylinder of a printing machine according to claim 12, characterized in that it maintains a constant level (9) of solvent (2) in the tank (4) during impregnation.

15. The method for impregnating, with a solvent, a fabric for cleaning the blanket and the metal printing cylinder of a printing machine according to claim 12, characterized in that it modifies the configuration of the feed path (7) to adjust the extent of the area of contact (8).
